(19) United States
(12) Patent Application Publication
(10) Pub. No.: US 2006/0166702 A1
(43) Pub. Date: Jul. 27, 2006

(54) Cellular telephone with ear proximity display and lighting control

(76) Inventors: Paul H. Dietz, Hopkinton, MA (US); Darren L. Leigh, Belmont, MA (US); William S. Yerazunis, Acton, MA (US)

Correspondence Address: Patent Department;Mitsubishi Electric Research Laboratories, Inc., 201 Broadway, Cambridge, MA, 02139, US

(21) Appl. No.: 11/041,500

(22) Filed: Jan. 24, 2005

(51) Int. Cl. H04M 1/66

(52) U.S. Cl. 455/566; 455/41.2

(57) ABSTRACT

A cell phone includes illuminated components and a proximity sensor. The proximity sensor detects when the cell phone is coupled to the ear of a user. Therefore, the proximity detector is placed, in part, near the loudspeaker of the cell phone. The proximity sensor controls the illumination of the illuminated components according to the coupling. The illumination is off when coupled, an on when not coupled. The amount of illumination can depend to the intensity of ambient light as measured by a photodiode.

### FIELD OF THE INVENTION

This invention relates generally to battery operated devices, and more particularly to reducing power consumption and increasing usability of cellular telephones.

### BACKGROUND OF THE INVENTION

Power consumption is an important issue for battery operated devices, such as cellular telephones (cell phones). Therefore, cell phones attempt to reduce power in a number of ways. For example, when a call is not in progress, the cell phone only searches for an incoming call periodically, and then returns to a reduced power state with the receiver off.

Many modern cell phones have large, color displays and backlit keypads. Some cell phones have video capabilities. Running these systems is a significant drain on the battery. Indeed, a recent study indicates that the rate of increase of power consumption in cell phones is three times the rate of increase of the amount of energy that can be stored in batteries, see Economist, Vol. 374, No. 8408, page 56, Jan. 8-14, 2005.

In order to increase battery life, phone designers attempt to program the system so as to only light the display and keypad when needed. Typically, they only turn on when some user action occurs or a call is received or ended. In addition, the display dims or turns off automatically after a short predetermined time of inactivity to further reduce power consumption. More advanced cell phones also automatically adjust the level of illumination according to the amount of ambient light.

Unfortunately, cell phone designers do not have enough information to know when the lighting should be turned on and off. For example, many automated response systems (ARS) require the user to enter menu choices via the keypad in the middle of a call. The usual frustrating and wasteful result is that the display screen and keypad are dark until after the user presses a key. The chance of hitting the wrong key is great. Thus, the lights are off when the user needs them to be on, and on when they could be off.

Thousands and thousands of engineers and researchers each day are finding ways to reduce power consumption in cellular telephones without decreasing their usability. Yet, all over the world, hundreds of millions of cell phone users each day have to fumble in the dark to make sure the correct keys are pressed. This has been a long standing and major problem in search for a simple solution which, up to now, has amazingly escaped the world's best cell phone designers.

### SUMMARY OF THE INVENTION

The present invention uses an ear proximity sensor to automatically control illumination of cellular telephone (cell phone) components, such as the display screen and the keypad. The assumption is that there is no need to illuminate any of these components when the cell phone is pressed against an ear of a user. The other assumption is that the components may need to be illuminated when the cell phone is removed from the ear so that the user can perform additional operations.

### BRIEF DESCRIPTION OF THE DRAWINGS

FIG. 1 is a front view of a cellular telephone according to the invention; and

FIG. 2 is a block diagram of the cellular telephone of FIG. 1.

### DETAILED DESCRIPTION OF THE PREFERRED EMBODIMENT

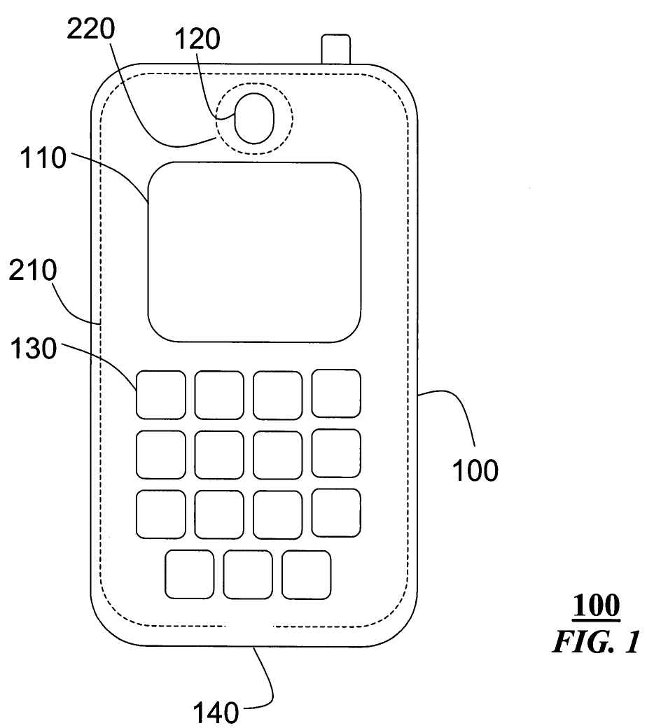

FIG. 1 shows a cellular telephone (cell phone) 100 according to the invention. The cell phone 100 includes a display screen 110, a speaker 120, a keypad 130 and a microphone 140. The cell phone is operated by a conventional battery, not shown. For simplicity, other components of the cell phone that are not central to the invention are omitted from the Figures.

The cell phone 100 according to the invention also includes an ear proximity sensor.

One proximity sensor is described in U.S. Pat. No. 6,771,768, “Real-time audio buffering for telephone handsets” issued to Dietz et al. on Aug. 3, 2004, incorporated herein by reference. That sensor controls the buffering of an output signal that is fed to a speaker of a telephone handset when the handset is removed from the ear. The buffered audio signal is played back when the handset is returned to the ear.

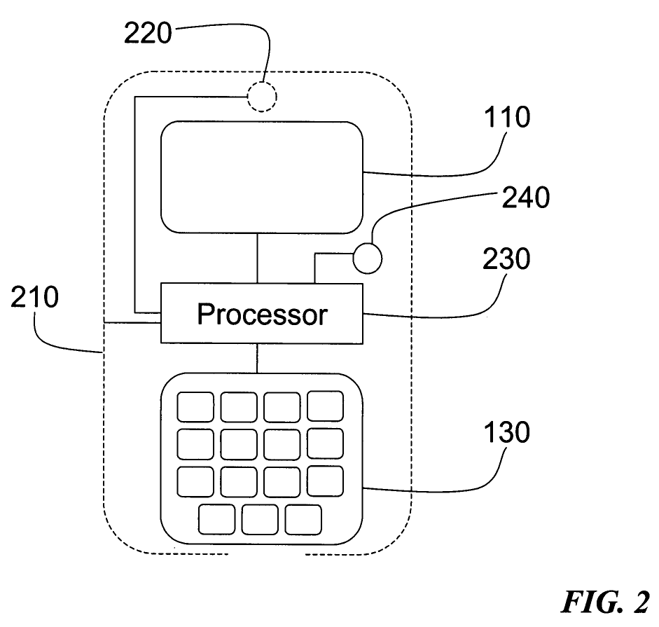

As shown in FIG. 2, the proximity sensor, in part, is in the form of an electro-conductive paint applied to the interior of the cell phone to create a large ground electrode 210. The coating can be applied to a large portion of the interior surface of the cell phone. In the cell phone, the ground plane can be the RF shield that is already required to reduce RF interference. A small, isolated ear electrode 220 forms the second part of the proximity sensor. Wires connect the electrodes to a processor 230. The processor is connected to the rest of the components, in particular the components that control the illumination of the display screen 110 and the keypad 130.

It should be noted that the proximity sensor can also use a short range infrared detector, a temperature detector, a pressure sensitive pad, ultra-sound range finder, or a mechanical switch that is depressed when in contact with the ear. The design of these components is well known.

The proximity sensor provides information to help control the illumination of the display and other illuminated components. A light sensor 240 is also connected to the processor to determine a level of ambient illumination.

The method of operation of the preferred embodiment is as follows. When the proximity sensor signals that an ear is detected in close proximity, the processor turns off all illuminated components including the display screen 110 and back lighting for the keypad 130. When the user is listening or talking, there is no need to see the display or touch the keypad. Therefore, power consumption can be reduced by turning the illumination off without negatively impacting the user.

When the cell phone is removed from the ear, the proximity sensor signals the processor to enable the illumination. The amount of illumination can be depend on the level of ambient light as sensed by the light sensor 240. In addition, the illumination can turn off after some predetermined period of time to further reduce power consumption, even though the cell phone is removed from the ear. The particulars depend upon particular features and programming of the cell phone. These variations fall within the scope of the present invention in that they all use ear proximity sensing to control illumination of cell phone components.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A cell phone, comprising:
illuminated components;
a proximity sensor;
means, connected to the proximity sensor, for measuring a coupling between the cell phone and an ear of a user; and
means for controlling an illumination of the illuminated components according to the coupling.

2. The cell phone of claim 1, in which the proximity sensor further comprises:
a ground electrode;
an isolated ear electrode; and
a capacitance measuring circuit coupled to the electrodes.

3. The cell phone of claim 1, in which the ground electrode is substantially larger than the isolated ear electrode, and the electrodes are in form of an electro-conductive coating applied to an interior portion of the cell phone.

4. The telephone handset of claim 1 wherein the proximity sensor further comprises:
a mechanical switch; and
a circuit for measuring a state of the switch.

5. The cell phone of claim 1, in which the proximity sensor uses a short range optical detector.

6. The cell phone of claim 1, in which the proximity sensor uses a temperature detector.

7. The cell phone of claim 1, in which the proximity sensor uses a pressure sensitive pad.

8. The cell phone of claim 1, in which the proximity sensor uses an ultra-sound range finder.

9. The cell phone of claim 1, in which the proximity sensor uses a mechanical switch that is depressed when in contact with the ear.

10. The cell phone of claim 1, in which the illuminated components include a display screen and a keypad.

11. The cell phone of claim 1, further comprising:
means for sensing a level of ambient illumination; and
means for controlling an amount of the illumination for the illuminated components according to the level of ambient illumination.

12. The cell phone of claim 1, in which the illumination is turned off when the cell phone is coupled with the ear and turned on when the cell phone is not coupled with the ear.

13. A method for illuminating components of a cell phone, comprising:
measuring a coupling between the cell phone and an ear of a user; and
illuminating the components according to the coupling.

14. The method of claim 13, further comprising:
sensing a level of ambient illumination; and
controlling an amount of the illumination for the illuminated components according to the level of ambient illumination.

15. The method of claim 13, in which the illumination is turned off when the cell phone is coupled with the ear and turned on when the cell phone is not coupled with the ear.
